(19) United States
(12) Patent Application Publication
(10) Pub. No.: US 2014/0001856 A1
(43) Pub. Date: Jan. 2, 2014

(54) MULTILEVEL POWER CONVERTER

(71) Applicants: Mohammed Agamy, Niskayuna, NY (US); Ahmed Elasser, Latham, NY (US); Maja Harfman Todorovic, Niskayuna, NY (US)

(72) Inventors: Mohammed Agamy, Niskayuna, NY (US); Ahmed Elasser, Latham, NY (US); Maja Harfman Todorovic, Niskayuna, NY (US)

(73) Assignee: GENERAL ELECTRIC COMPANY, SCHENECTADY, NY (US)

(21) Appl. No.: 13/538,819

(22) Filed: Jun. 29, 2012

(51) Int. Cl. H02M 3/155; H02J 1/00

(52) U.S. Cl. CPC H02M 3/155; H02J 1/00
USPC 307/43; 323/311

(57) ABSTRACT

A partial power converter includes a converter leg including an upper portion comprising at least one diode connected to a positive output node of an output terminal of the partial power converter and a lower portion comprising at least two switches connected in series with each other and with the at least one diode and to a negative output node of the output terminal of the partial power The partial power converter also includes at least one flying capacitor connected between the at least two switches at a first end and to either of the upper portion of the converter leg or the positive output node of the partial power converter at a second end.

### STATEMENT REGARDING FEDERALLY SPONSORED RESEARCH & DEVELOPMENT

This invention was made with U.S. Department of Energy support under contract number DE-EE0000572. The Government has certain rights in the invention.

### BACKGROUND

The invention generally relates to power conversion systems and, more particularly, to a multilevel DC-DC power conversion system.

Power conversion systems are used in numerous applications for converting power from one form to another. One such converter is a DC-DC power converter that is used to convert the voltage and current levels of an input DC power source. DC-DC power converters may employ different approaches to convert the input DC power.

In one approach, a DC-DC power converter includes a circuit that switches a portion of the input DC power at different frequencies that is then filtered to provide a required DC power output at different voltage and current levels. The circuit in the DC power converter includes switches that are selected based on the switching characteristics such as voltage rating, current rating, and operating frequency range.

Generally, in high power applications, semiconductor switches such as insulated gate bipolar transistors (IGBTs) are used to convert the input source from one form to another (e.g. dc/dc, dc/ac). Specifically, in solar applications, silicon IGBTs are used for converting DC power generated by photovoltaic modules to either a different DC level or to AC power. However, silicon (Si) IGBTs have a limited switching frequency range which leads to the use of passive components with sizes that are larger and more expensive than is desirable. For lower power applications, MOSFETs can be used and thus increasing the switching frequency and consequently reducing the size of passive components.

Silicon carbide (SiC) switches such as MOSFETs and JFETs have recently been used in DC-DC power converters. The SiC switches have a higher switching frequency range compared to the silicon IGBTs and higher voltage and power capabilities compared to silicon MOSFETs but are still more expensive than similar silicon devices and can increase the overall cost of the DC-DC power converter.

Hence, there is a need for an improved system to address the aforementioned issues.

### BRIEF DESCRIPTION

Briefly, in accordance with one embodiment, a partial power converter is provided. The power converter includes a converter leg that includes an upper portion and a lower portion connected to a positive output node and a negative output node of an output terminal respectively. The upper portion includes at least one diode, and the lower portion includes at least two switches connected in series with each other. The at least two switches are further connected to the at least one diode and to the negative output node. The power converter also includes an inductor connected between an input terminal of the partial power converter and an intermediate node between the upper portion and the lower portion of the converter leg, an output capacitor connected between the input terminal of the partial power converter and the positive output node of the partial power converter, and at least one flying capacitor connected between the at least two switches at a first end and to either of the upper portion of the converter leg or the positive output node of the partial power converter at a second end.

In accordance with another embodiment of the invention, a solar power conversion system is provided. The system includes photovoltaic modules for generating DC power. The system also includes a partial power converter for converting DC power received from the photovoltaic modules. The power converter includes a converter leg that includes an upper portion and a lower portion connected to a positive output node and a negative output node of an output terminal respectively. The upper portion includes at least one diode, and the lower portion includes at least two switches connected in series with each other. The at least two switches are further connected to the at least one diode and to the negative output node. The power converter also includes an inductor connected between an input terminal of the partial power converter and an intermediate node between the upper portion and the lower portion of the converter leg, an output capacitor connected between the input terminal of the partial power converter and the positive output node of the partial power converter, and at least one flying capacitor connected between the at least two switches at a first end and to either of the upper portion of the converter leg or the positive output node of the partial power converter at a second end.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of one embodiment of a DC-DC partial power converter in accordance with an embodiment of the invention.

FIG. 2 is a schematic representation of a DC-DC partial power converter depicting an inner switch and an outer switch in a conducting state in accordance with an embodiment of the invention.

FIG. 3 is a schematic representation of a DC-DC partial power converter depicting an inner switch in a conducting state and an outer switch in a non-conducting state in accordance with an embodiment of the invention.

FIG. 4 is a schematic representation of a DC-DC partial power converter depicting an inner switch and an outer switch in a non-conducting state in accordance with an embodiment of the invention.

FIG. 5 is a schematic representation of a DC-DC partial power converter depicting an inner switch in a conducting state and an outer switch in a non-conducting state in accordance with an embodiment of the invention.

FIG. 6 is a schematic representation of a DC-DC partial power converter depicting an inner switch and an outer switch in a conducting state in accordance with an embodiment of the invention.

FIG. 7 is a graphical representation of waveforms depicting operation of the DC-DC partial power converter in accordance with an embodiment of the invention.

FIG. 8 is a graphical representation of collector voltages (Vice) across an inner switch and an outer switch and an output voltage across the output terminal during the non-conducting state of the inner switch and the outer switch in accordance with an embodiment of the invention.

FIG. 9 is a graphical representation of voltages across the diodes in a two diode configuration of the partial power converter and voltage across a flying capacitor during a conducting state of an inner switch and an outer switch in accordance with an embodiment of the invention.

FIG. 10 is a schematic representation of one embodiment of a DC-DC partial power converter including a more than two switches and a plurality of flying capacitors in accordance with an embodiment of the invention.

FIG. 11 is a schematic representation of an alternative embodiment of a DC-DC partial power converter including more than two switches and a plurality of flying capacitors in accordance with an embodiment of the invention.

FIG. 12 is a schematic representation of an interleaved DC-DC partial power converter in accordance with an embodiment of the invention.

FIG. 13 is a schematic representation of an alternate embodiment of an interleaved DC-DC partial power converter in accordance with another embodiment of the invention.

FIG. 14 is a block diagram representation of a solar power conversion system including DC-DC partial power converters in accordance with an embodiment of the invention.

### DETAILED DESCRIPTION

Embodiments of the present invention include a partial power converter. The term “partial power converter” is used interchangeably herein with “power converter.” The power converter includes a converter leg that includes an upper portion and a lower portion connected to a positive output node and a negative output node of an output terminal respectively. The upper portion includes at least one diode, and the lower portion includes at least two switches connected in series with each other. The at least two switches are further connected to the at least one diode and to the negative output node. The power converter also includes an inductor connected between an input terminal of the partial power converter and an intermediate node between the upper portion and the lower portion of the converter leg, an output capacitor connected between the input terminal of the partial power converter and the positive output node of the partial power converter, and at least one flying capacitor connected between the at least two switches at a first end and to either of the upper portion of the converter leg or the positive output node of the partial power converter at a second end. The above mentioned configuration of the power converter enables partial conversion of the DC power by switching the at least two switches, where only a fraction of the power is processed through the power converter to generate the voltage difference between an input voltage and an output voltage. This voltage difference appears across the output capacitor. In one embodiment, the power converter includes a controller that is programmed to execute the steps of sequentially switching the at least two switches to a non-conduction mode wherein the switch connected farthest from the intermediate node is switched first and then sequentially switching the at least two switches to a conduction mode wherein the switch connected nearest to the intermediate node is switched first.

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The term “connected” is not restricted to physical or mechanical connections, and can include electrical connections, whether direct or indirect. Furthermore, the term “controller” includes either a single component or a plurality of components, which are either active and/or passive provide the described function.

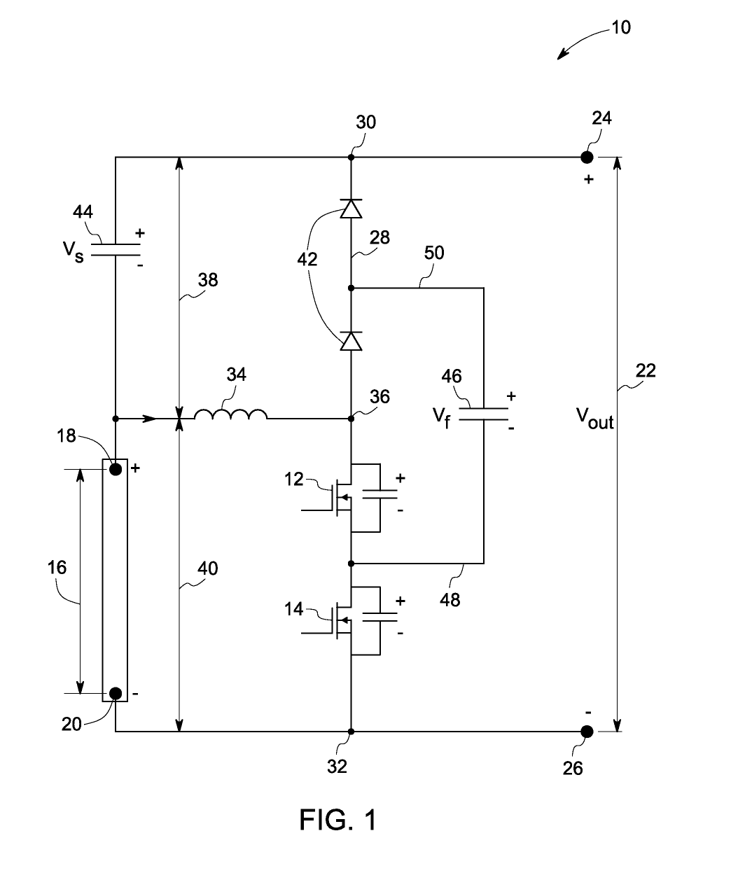

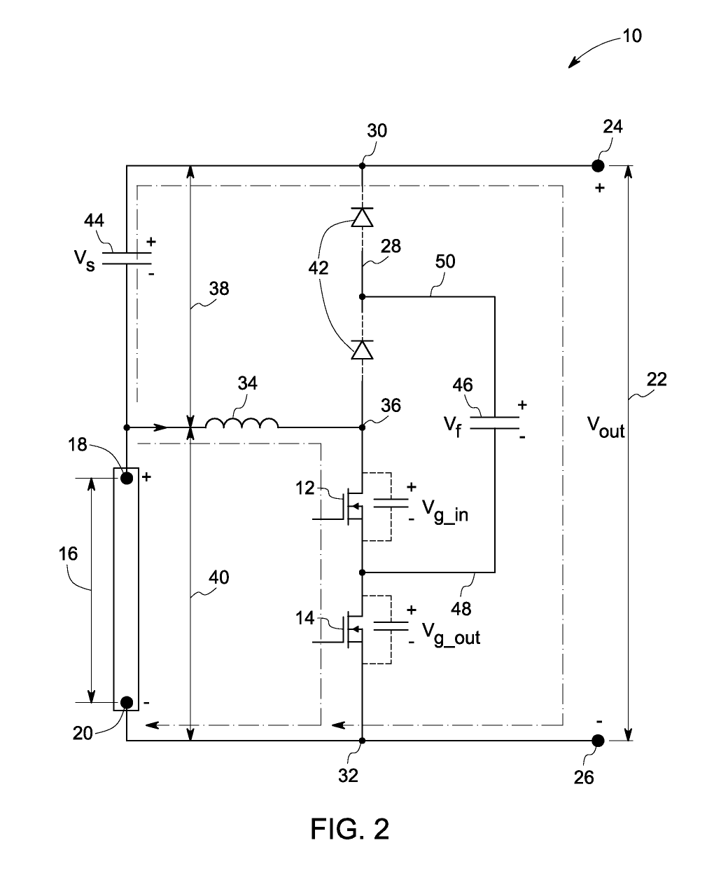

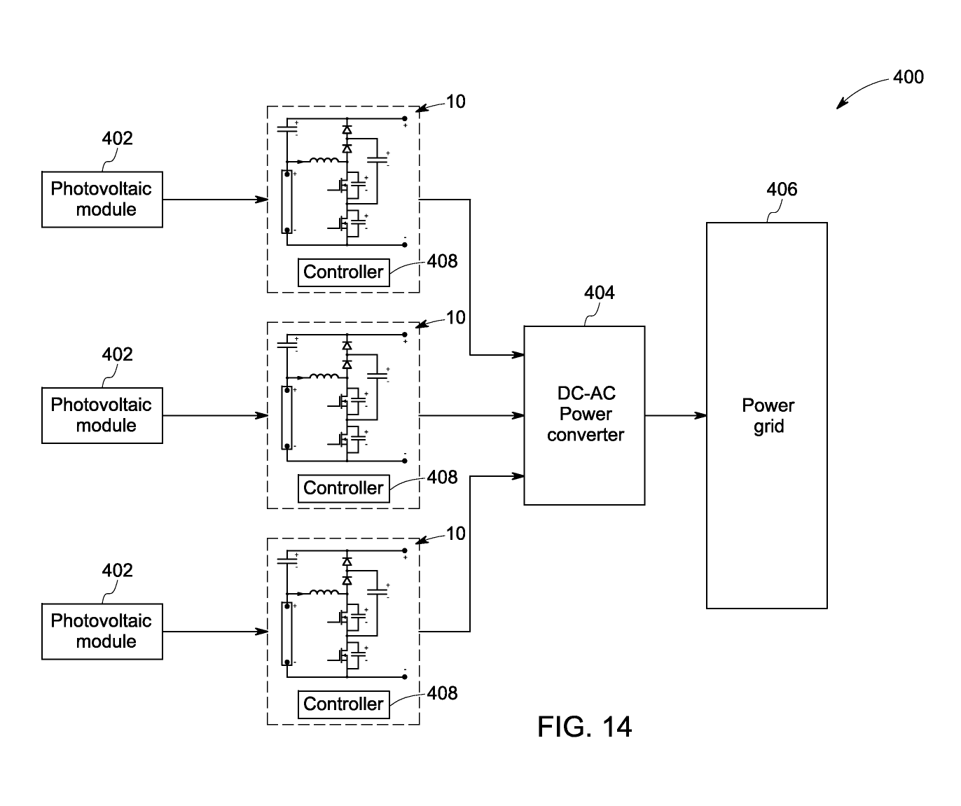

FIG. 1 is a schematic representation of one embodiment of a three-level DC-DC partial power converter 10 including an inner switch 12 and an outer switch 14 in accordance with an embodiment of the invention. The power converter 10 includes an input terminal 16 comprising a positive input node 18 and a negative input node 20. The power converter 10 is connected to a power source (such as photovoltaic modules 402 of FIG. 14) and receives input power via the input terminal 16. The power converter 10 includes an output terminal 22 that comprises a positive output node 24 and a negative output node 26. The power converter 10 includes a converter leg 28 that comprises a first end 30 and a second end 32 that are connected to the positive output node 24 and the negative output node 26 respectively. The power converter 10 includes an inductor 34 connected to the positive input node 18 and the converter leg 28. The inductor 34 is connected to the converter leg 28 at an intermediate node 36 that divides the converter leg 28 in an upper portion 38 and a lower portion 40. The lower portion 40 includes the inner switch 12 and the outer switch 14 connected in series with each other. The upper portion 38 includes two diodes 42, 43 connected in series to the inner and the outer switches 12, 14. The power converter 10 also includes an output capacitor 44 that is connected between the input terminal 16 and the positive output node 24 and a flying capacitor 46. A first end 48 of the flying capacitor 46 is connected between the inner switch 12 and the outer switch 14, and a second end 50 is connected between the two diodes 42, 43. Based on the switching, the operation of the three-level DC-DC partial power converter 10 can be divided into five stages as discussed with reference to FIG. 2-6 below.

FIG. 2 is a schematic representation of three-level DC-DC partial power converter 10 depicting the inner switch 12 and the outer switch 14 in a conducting state in accordance with an embodiment of the invention. Stage one represents a state in which the inner switch 12 and the outer switch 14 are in a conducting state, and gate voltage is applied to the inner switch (Vg_in) and the outer switch (Vg_out). The current thus flows through the inductor 34, the inner switch 12, and the outer switch 14.

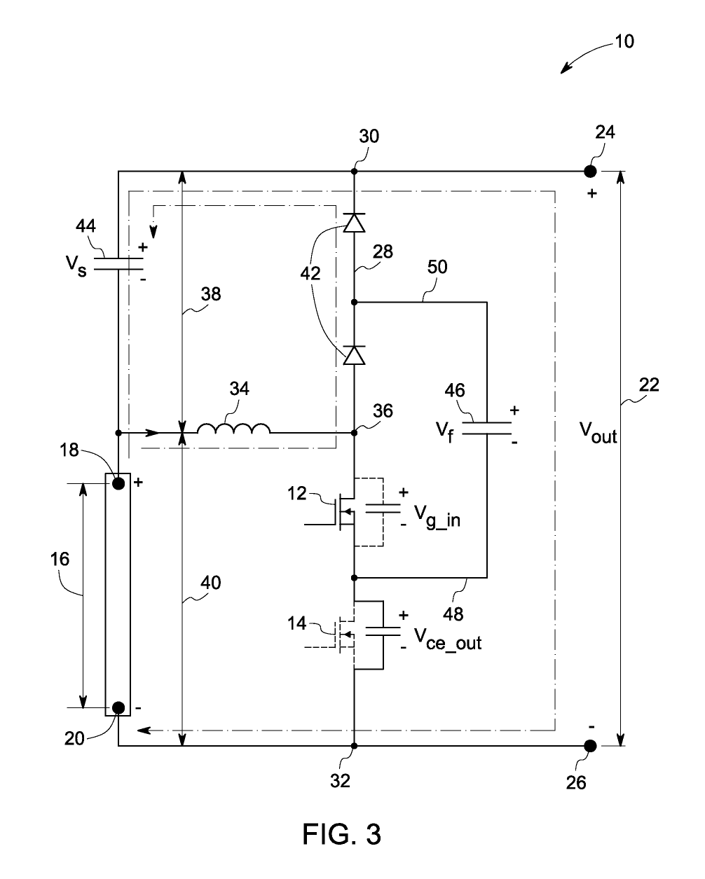

FIG. 3 is a schematic representation of the DC-DC partial power converter 10 depicting the inner switch 12 in a conducting state and the outer switch 14 in a non-conducting state in accordance with an embodiment of the invention. In stage two, the outer switch 14 is switched to a non-conducting state and the inner switch 12 remains in the conducting state. During this stage, the two diodes 42, 43 start conducting and voltage starts building on the outer switch 14 represented by VQ_out. The outer switch voltage (V_{Q}_{_{—}}ₒᵤₜ) increases until it reaches a value equal to half of the output voltage (Vout) at the end of stage two. The voltage across the flying capacitor 46 remains steady at a value equal to half of the output voltage (Vout). Notably, during the conducting state of the inner and the outer switches, the output voltage is split between the diodes and flying capacitor, and, during the non-conducting state of the inner and the outer switches, the voltage is split between the flying capacitor and the switches.

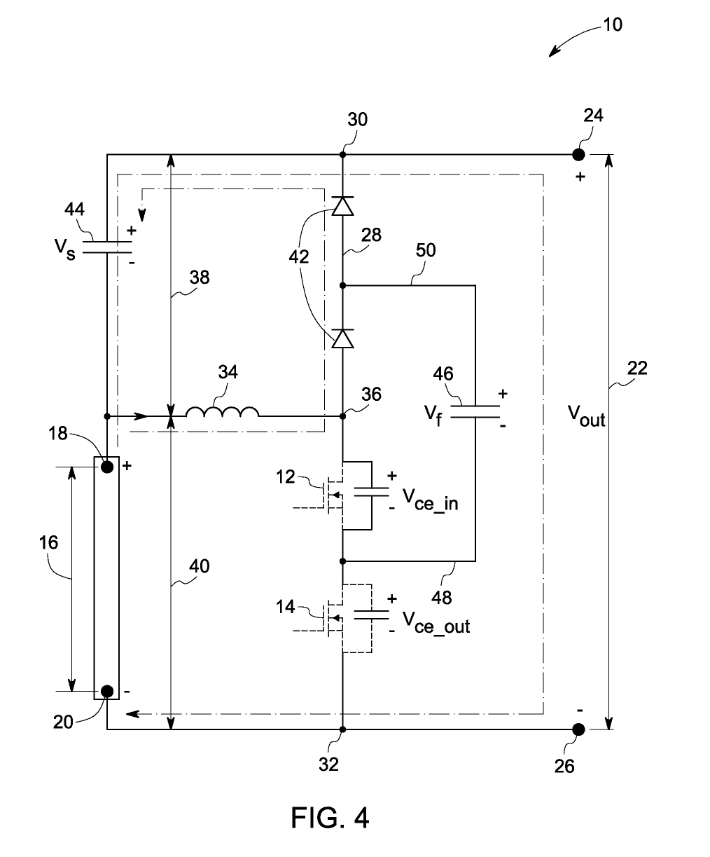

FIG. 4 is a schematic representation of the DC-DC partial power converter 10 depicting the inner switch 12 and the outer switch 14 in a non-conducting state in accordance with an embodiment of the invention. In stage three, the inner switch 12 is also switched to a non-conducting state resulting in both the inner switch 12 and the outer switch 14 being in the non-conducting state. Initially, the two diodes 42, 43 are still conducting as the current is unable to flow in the lower portion 40 of the converter leg 28. As the inner switch 12 is in a non-conducting state, an inner switch voltage (V_{Q}_{_{—}}ᵢₙ) starts building up until it achieves voltage balance by reaching half the output voltage. The inner switch voltage (V_{Q}_{_{—}}ᵢₙ) increases until the outer switch voltage (V_{Q}_{_{—}}ₒᵤₜ) and the inner switch voltage (V_{Q}_{_{—}}ᵢₙ) reach an equal value equal to half of the output voltage. At the end of stage three, V_{Q}_{_{—}}ₒᵤₜ and V_{Q}_{_{—}}ᵢₙ are at an equal value. The flying capacitor voltage (Vf) remains at Vout/2.

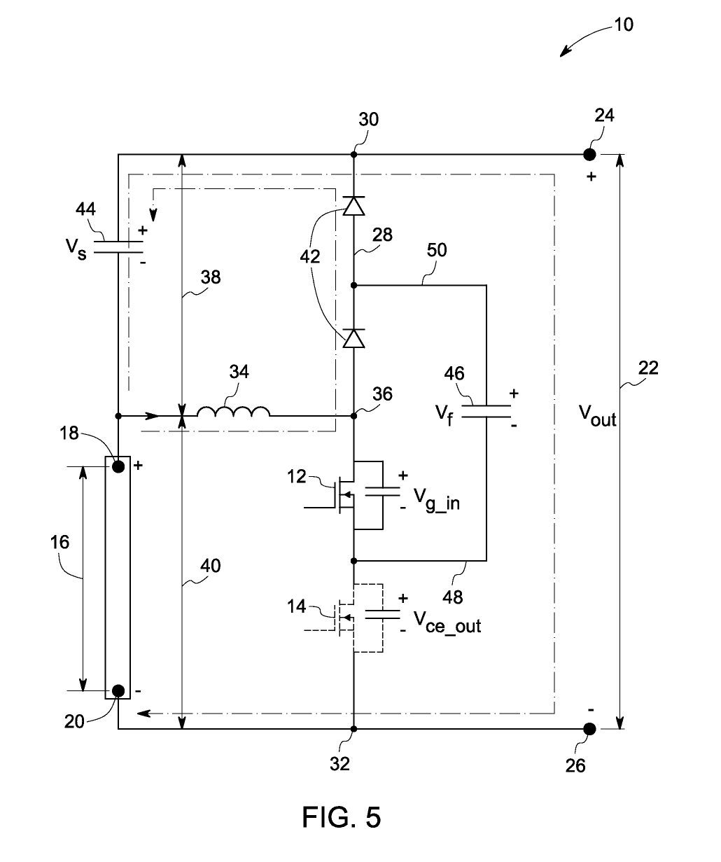

FIG. 5 is a schematic representation of the DC-DC partial power converter 10 depicting the inner switch 12 in a conducting state and the outer switch 14 in a non-conducting state in accordance with an embodiment of the invention. In stage four, if the inductor 34 is operating in continuous conduction mode, the two diodes 42, 43 are still conducting and the current is flowing through the upper portion 38 of the converter leg 28. In case of discontinuous conduction mode, the diodes cease to conduct as the inductor current decays to zero. The inner switch 12 is switched to a conducting state that results in discharging of V_{Q}_{_{—}}ᵢₙ. The outer switch voltage V_{Q}_{_{—}}ₒᵤₜ remains unchanged in stage four.

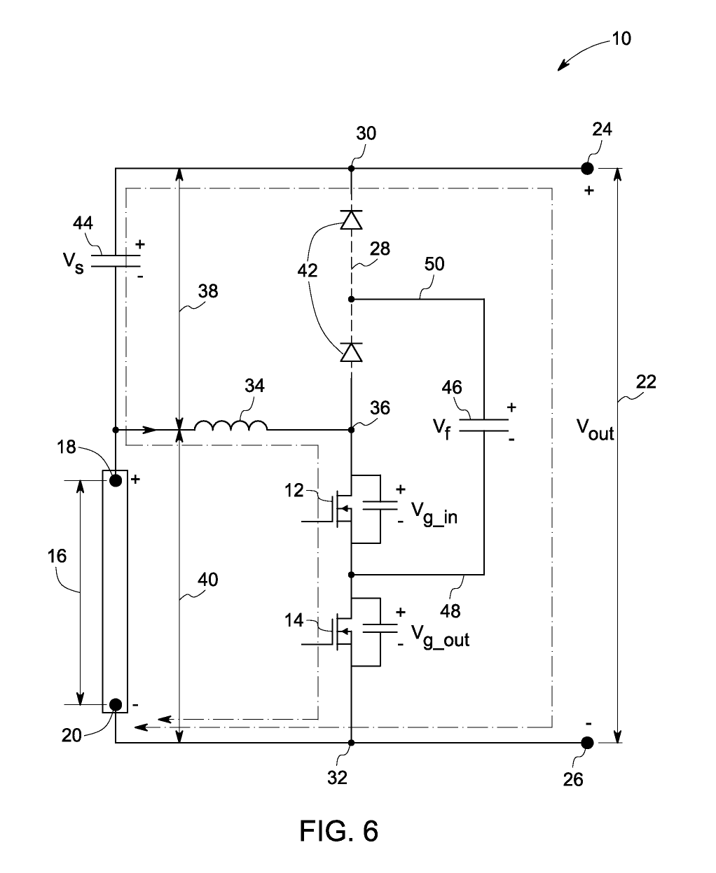

FIG. 6 is a schematic representation of the DC-DC partial power converter 10 depicting the inner switch 12 and the outer switch 14 in a conducting state in accordance with an embodiment of the invention. In stage five, the outer switch 14 is switched to a conducting state that results in discharging of the outer switch voltage V_{Q}_{_{—}}_{out. The end of stage five results in a state equal to stage one, and the operation from stage one to stage five is repeated continuously during operation.}

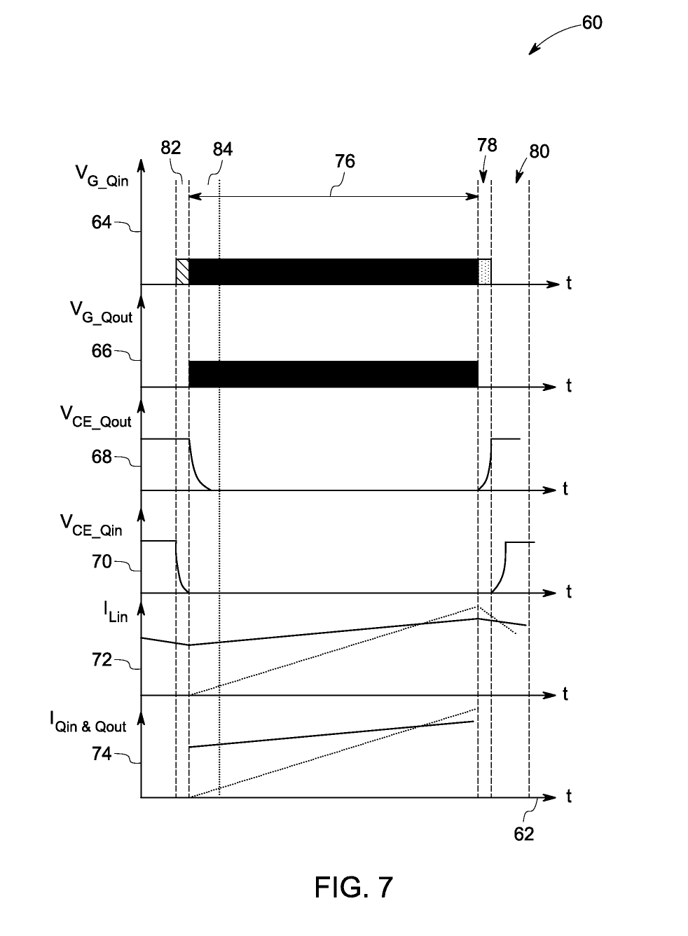

FIG. 7 is an exemplary graphical representation 60 of waveforms depicting operation of the DC-DC partial power converter (FIG. 1) in accordance with an embodiment of the invention. The X-axis is represented by the reference numeral 62 and represents time. The Y-axis represents multiple variables including a gate voltage at the inner switch (Vg_in) in volts represented by reference numeral 64, a gate voltage at the outer switch (Vg_out) in volts represented by reference numeral 66, a switch voltage of the outer switch (V_{Q}_{_{—}}ₒᵤₜ) in volts represented by reference numeral 68, a switch voltage of the inner switch (V_{Q}_{_{—}}ᵢₙ) in volts represented by reference numeral 70, current flowing through the inductor (I_{L}) in amperes represented by reference numeral 72 and current flowing through the inner switch and the outer switch (I_{Qin}, I_{Qout}) in amperes represented by reference numeral 74.

The operation as discussed above can be divided into five portions represented by reference numerals 76, 78, 80, 82, 84 each representing a respective stage of operation. Portion 76 represents stage one of operation in which the inner switch and the outer switch are in a conducting state. As can be seen, both the switches are gated with voltages Vg_in and Vg_out, and the switch voltage for the inner switch V_{Q}_{_{—}}ᵢₙ and the outer switch V_{Q}_{_{—}}ₒᵤₜ are zero. The current in the inductor and the switches is increasing steadily during the span of portion 76.

Portion 78 represents stage two of operation in which the inner switch is in a conducting state and the outer switch is switched to a non-conducting state. The gate voltage of the outer switch Vg_out has become zero, and the switch voltage V_{Q}_{_{—}}ₒᵤₜ is building up on the outer switch. The V_{Q}_{_{—}}ₒᵤₜ increases until it reaches a value which is half of the output voltage (Vout). The inductor starts discharging through the diodes, and the current in the inductor (I_{L}) decreases within the portion 78. The discharging of the inductor depends upon the mode of operation of the inductor. In one embodiment, the inductor can be operated in a continuous conduction mode (represented by the solid line) or a discontinuous conduction mode (represented by the dotted line). The inductor current (I_{L}) would start decreasing as the energy is transferred to the output capacitor.

Portion 80 represents stage three of operation in which the outer switch is in the non-conducting state, and the inner switch is switched to the non-conducting state. As illustrated, Vg_in and Vg_out become zero, and V_{Q}_{_{—}}ₒᵤₜ remains the same with respect to the V_{Q}_{_{—}}ₒᵤₜ in stage two above. However, V_{Q}_{_{—}}ᵢₙ increases to a level equal to V_{Q}_{_{—}}ₒᵤₜ such that the sum of V_{Q}_{_{—}}ᵢₙ and V_{Q}_{_{—}}ₒᵤₜ is equal to Vout. The inductor current (I_{L}) as mentioned above steadily decreases over stage three to zero in the case of discontinuous conduction mode (represented by the dotted line) or reaches a minimum positive value in the case of continuous conduction mode (represented by the solid line). The current in the inner switch (I_{Qin}) and the outer switch (I_{Qout}) is zero as both switches are in a non-conducting state.

Portion 82 represents stage four of operation in which the inner switch is switched to a conducting state, and the outer switch remains in the non-conducting state. The inner switch voltage (V_{Q}_{_{—}}ᵢₙ) starts falling and reaches zero in stage four. The inner switch is thus switched at zero current, which significantly reduces the switching losses. The outer switch gate voltage (Vg_out) is still zero, and the outer switch voltage (V_{Q}_{_{—}}ₒᵤₜ) remains the same as in stage three. The inductor current (I_{L}) remains zero in the case of discontinuous conduction mode or slightly decreases during stage four as shown in the case of continuous conduction mode. The current in the outer switch (I_{Qout}) and the inner switch (I_{Qin}) remains zero as the load current is still flowing through the diodes.

Portion 84 represents stage five of operation in which the inner switch is in a conducting state and the outer switch is switched to a conducting state. The switch voltage (V_{Q}_{_{—}}ₒᵤₜ) for the outer switch decreases to zero, and the switch voltage (V_{Q}_{_{—}}ᵢₙ) for the inner switch remains zero. The inductor current (I_{L}) starts increasing as the inductor energy is building up. The current in the inner switch and the outer switch starts increasing as both switches are in a conducting state which is the same state as stage one. These stages are repeated again during the operation of the three-level DC-DC partial power converter.

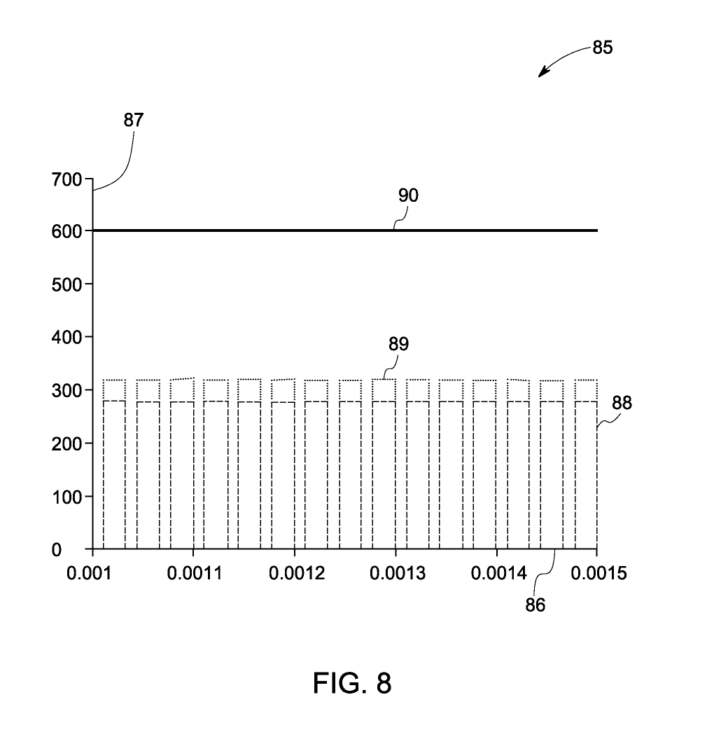

FIG. 8 is a graphical representation 85 of collector voltages across the inner switch and the outer switch with respect to the output voltage (Vout) during the non-conducting states of the inner switch and the outer switch in accordance with an embodiment of the invention. The X-axis 86 represents the time in seconds. The Y-axis 87 represents the voltage in volts. Curve 88 represents the collector voltage (V_{Q}_{_{—}}ᵢₙ) of the inner switch during operation. Curve 89 represents the collector voltage (V_{Q}_{_{—}}ₒᵤₜ) of the outer switch during operation and Curve 90 represents the output voltage (Vout) at the output terminal. As illustrated, V_{Q}_{_{—}}ᵢₙ is almost equal to V_{Q}_{_{—}}ₒᵤₜ. The sum of V_{Q}_{_{—}}ₒᵤₜ and V_{Q}_{_{—}}ᵢₙ is equal to the output voltage Vout. Ideally, the voltages across Qin and Qout should be equal, however, for practical cases small unbalances in capacitor values between the output capacitor and flying capacitor values may lead to slight deviations in device voltages around Vout/2.

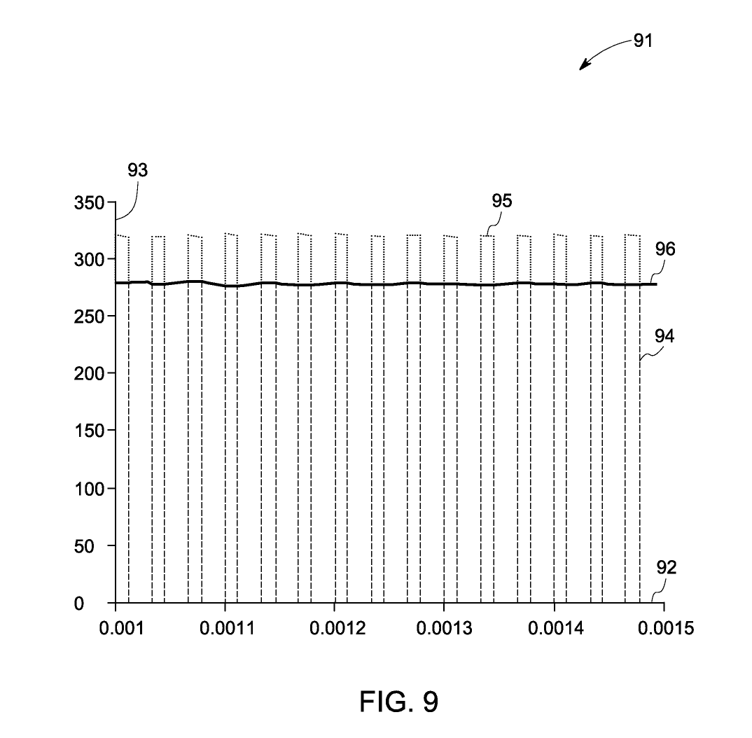

FIG. 9 is a graphical representation 91 of voltages across the diodes in a two diode configuration of the three-level partial power converter and the voltage across the flying capacitor during the conducting states of the inner and the outer switch in accordance with an embodiment of the invention. X-axis 92 represents time in seconds. Y-axis 93 represents voltage in volts. Curve 94 represents voltage across an inner diode provided closer to the intermediate node on the converter leg. Curve 95 represents voltage across an outer diode provided after the inner diode on the converter leg. Curve 96 represents the voltage across the flying capacitor. As seen, the voltage at the inner diode is equal to the voltage across the flying capacitor and the voltage across the outer diode is slightly more than the voltage across the flying capacitor.

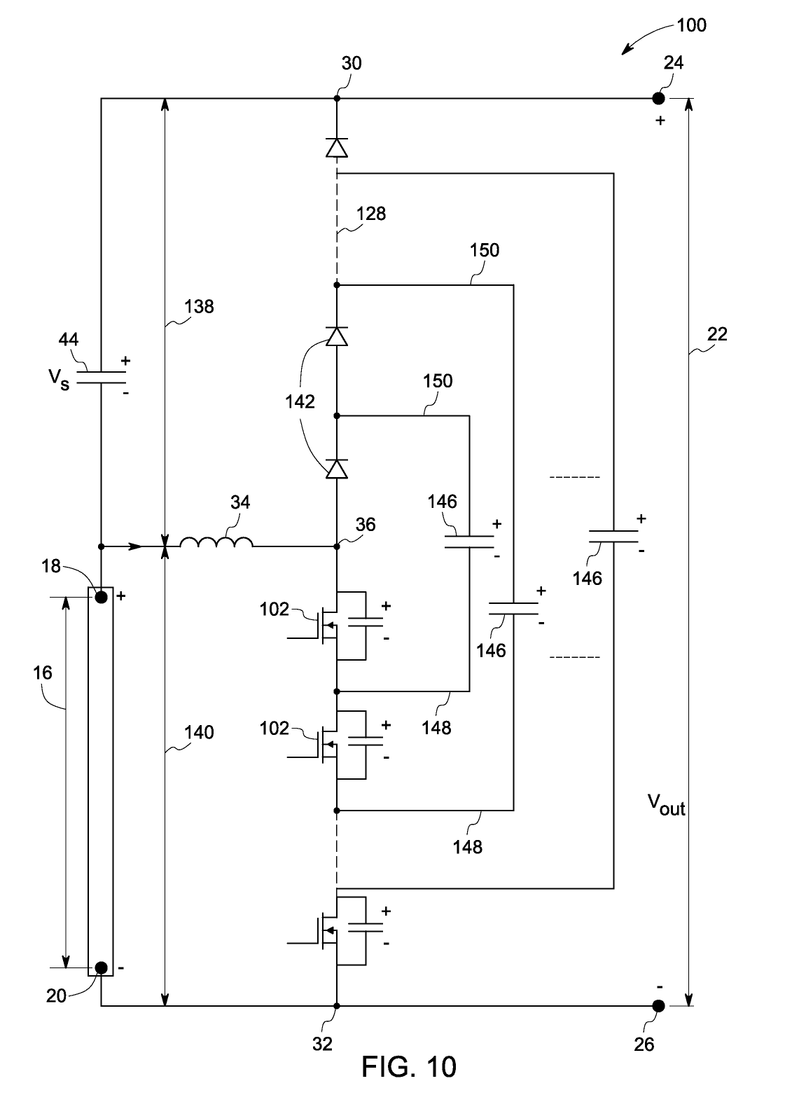

FIG. 10 is a schematic representation of one embodiment of a DC-DC partial power converter 100 including more than two switches 102 and a plurality of flying capacitors 146 in accordance with an embodiment of the invention. The above described operation of the power converter 10 can be applied to more than two switches, if desired. In one embodiment, more than two switches 102 may comprise N-channel MOSFETs (metal oxide semiconductor field effect transistors) such as available under the trademark CoolMOS from Infineon Technologies. In other embodiments, the switches may comprise wide bandgap materials such as silicon carbide or gallium nitride, for example. For a power converter including N number of switches 102, there would be N−1 number of flying capacitors 146 and M number of diodes 142, and the switch voltage (V_{Q}) at each of the switches may be referenced as Vout/N. In one embodiment, the first end 148 of each of the flying capacitors 146 is connected to the lower portion 140 of the converter leg 128 between a distinct pair of switches. For example, in a power converter including three switches Q1, Q2, Q3, the first end of capacitor C1 would be connected between Q1 and Q2, and the first end of capacitor C2 would be connected between Q2 and Q3. In one embodiment, the second end 150 of the flying capacitor would be connected to the upper portion 138 of the converter leg 128. In a specific embodiment, the second end 150 is connected between a distinct pair of diodes 142 at the converter leg 128 similar to the coupling between the switches 102 as mentioned above. In a more specific embodiment, the diodes 142 include low voltage diodes such as diodes having voltage ratings less than about 600 volts, for example.

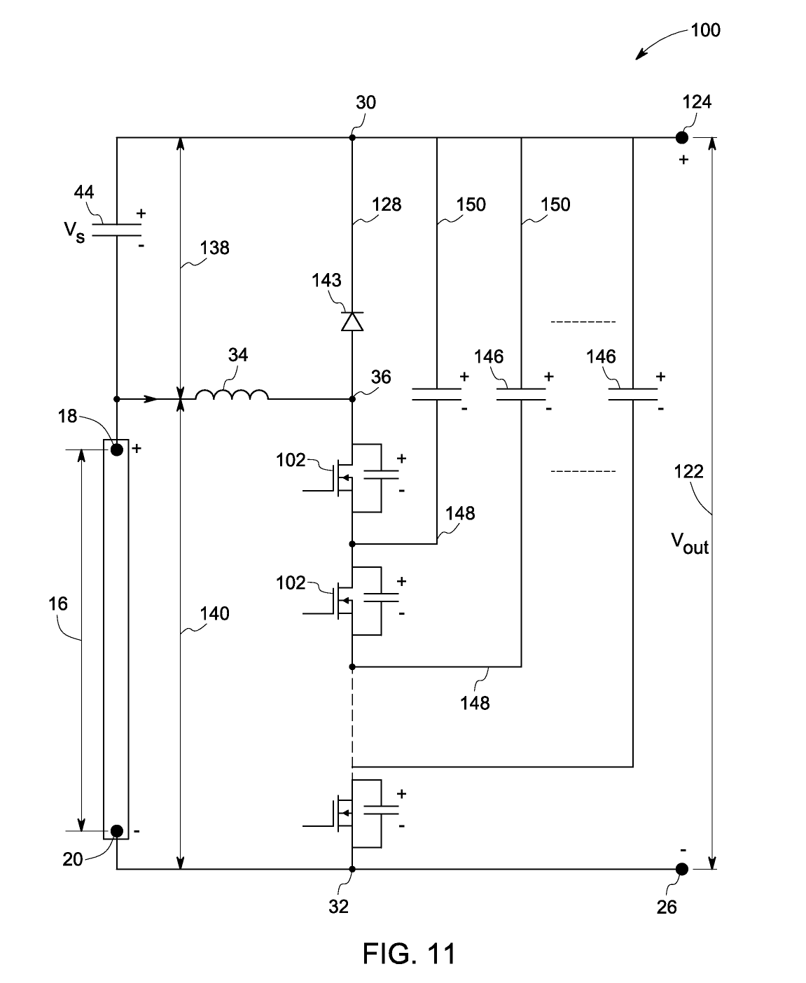

FIG. 11 is a schematic representation of an alternative embodiment of a DC-DC partial power converter 100 including more than two switches 102 and the plurality of flying capacitors 146. In the embodiment of FIG. 11, the second end 150 of each of the flying capacitors 146 is connected to the positive output node 124 of the output terminal 122. In this embodiment, upper portion 138 of the converter leg 128 may include a single diode 143 for conducting current during the non-conducting state of the switches 102. In such a configuration, N number of switches 102 and N−1 number of flying capacitors 102 can be used wherein the first end 148 of each of the flying capacitor 146 would be connected to the converter leg 128 between the distinct pair of switches as described in FIG. 10 above. In a specific embodiment, the high voltage diode may include but is not limited to silicon carbide Schottky (Junction Barrier Schottky or Merged PiN Schottky diodes) or bipolar PiN diodes.

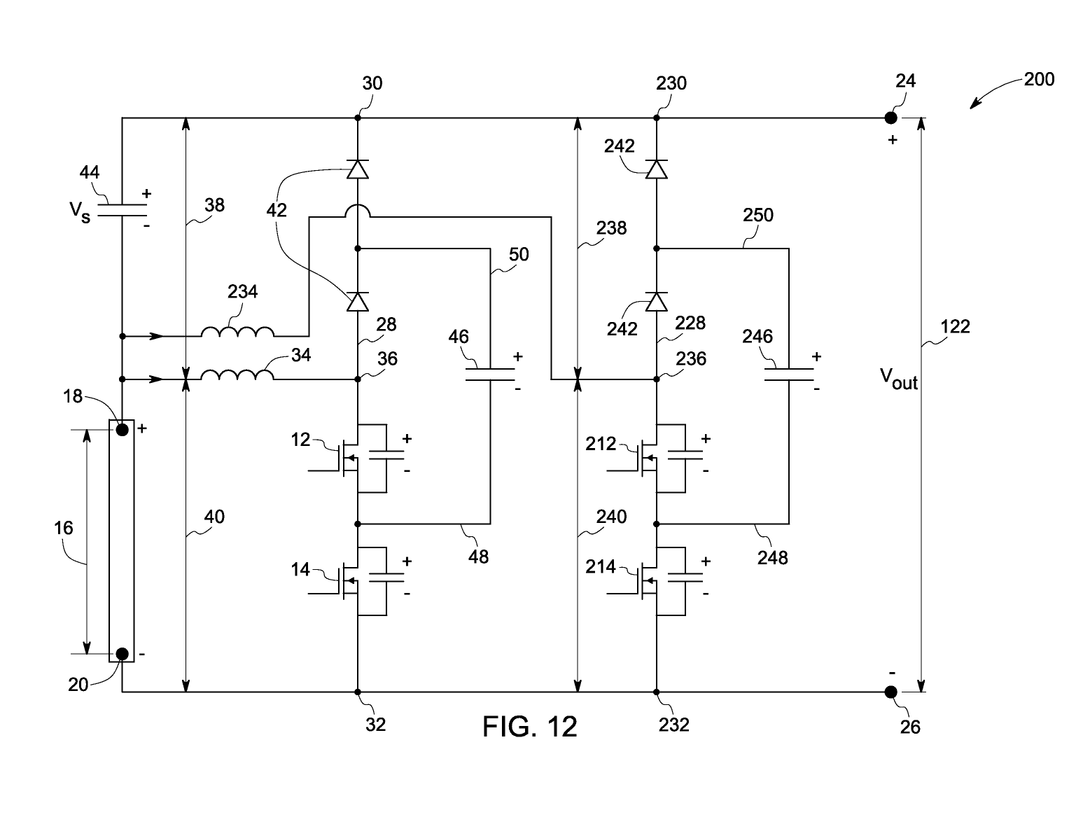

FIG. 12 is a schematic representation of an interleaved DC-DC partial power converter 200 including flying capacitors 46, 246 connected to the lower portion 40, 240 and the upper portion 38, 238 of the converter legs 28, 228 in accordance with an embodiment of the invention. Interleaved converters 200 are used in applications with higher power ratings. The use of interleaved converters 200 reduces the input current ripple, ensures redundancy, increases converter reliability, and improves light load efficiency. In one embodiment a transformer-less three-level partial power converter includes an interleaved three-level partial power converter 200 that receives input DC power from a common power source. The interleaved DC-DC partial power converter 200 includes one input terminal 16, one output terminal 122, and one output capacitor 44. The interleaved partial power converter includes an additional converter leg 228 and an additional inductor 234. The two inductors 34, 234 are connected to the two converter legs 28, 228 at intermediate nodes 36 and 236, and the converter legs 28 and 228 are connected to the positive output node 24 and the negative output node 26 at respective first ends 30, 230 and second ends 32, 232 of the converter legs 28 and 228. Each of the upper portions 38, 238 includes at least two diodes 42, 242 respectively and each of the lower portions 40, 240 includes an inner switch 12, 212 and an outer switch 14, 214 respectively. Each of the converter legs 28, 228 may be similar to the leg described in FIG. 1 above. In an exemplary embodiment, the interleaved three-level partial power converter 200 can include L number of inductors 34, 234 connected to L number of converter legs 28, 228. Additionally each converter leg 28, 228 may include T number of switches in the lower portion 40 of the converter leg 28 and D number of diodes 42 in the upper portion 38 of the converter leg 28 with T−1 number of flying capacitors 146 being connected to the lower portion 40 and the upper portion 38.

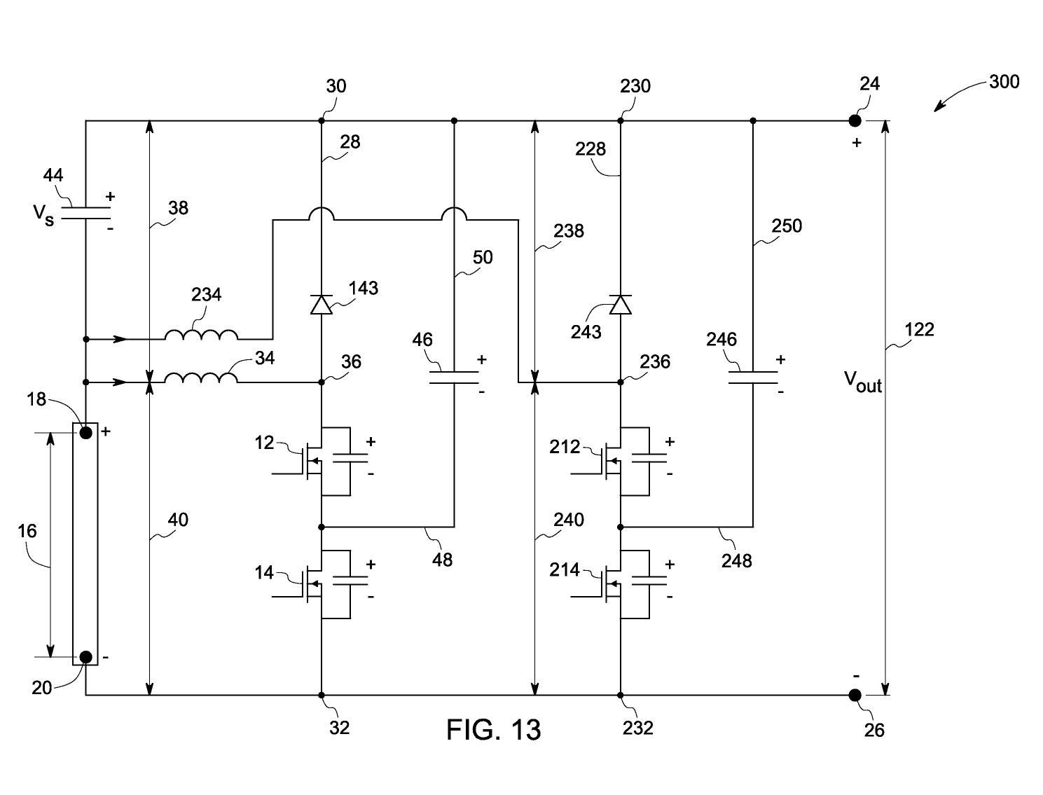

FIG. 13 is a schematic representation of an alternative embodiment of an interleaved DC-DC partial power converter 300 wherein the second ends 50, 250 of the flying capacitors 46, 246 are connected to the positive output node 24 of the output terminal 22 of the DC-DC partial power converter 300 in accordance with an embodiment of the invention. The configuration as described in FIG. 13 can be used to create an alternative embodiment of the interleaved DC-DC partial power converter 300 as shown. In this embodiment, an additional converter leg 228 is connected to the positive output node and the negative output node in the manner discussed above, and an additional inductor 234 is connected to the additional converter leg 228. The upper portion 38, 238 of each leg may include a single diode for operation.

FIG. 14 is a block diagram representation of a solar power generation system 400 including the DC-DC partial power converters 10 in accordance with an embodiment of the invention. The solar power generation system 400 includes photovoltaic modules 402 that generate DC power. The photovoltaic modules 402 are connected to DC-DC partial power converters 10. The DC power is transmitted to the DC-DC partial power converter 10 that converts the photovoltaic DC input into a constant DC output. The converted DC power is transmitted from each of the DC-DC partial power converter 10 to the DC-AC power converter 404 that converts it to grid compliant AC power. The AC power is fed to a power grid 406. One or more controllers 408 can be used to control the switches in the DC-DC partial power converters 10.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A partial power converter comprising:
a converter leg comprising an upper portion comprising at least one diode connected to a positive output node of an output terminal of the partial power converter and a lower portion comprising at least two switches connected in series with each other and with the at least one diode and to a negative output node of the output terminal of the partial power converter;
an inductor connected between an input terminal of the partial power converter and an intermediate node between the upper portion and the lower portion of the converter leg;
an output capacitor connected between the input terminal of the partial power converter and the positive output node; and
at least one flying capacitor connected between the at least two switches at a first end and to either of the upper portion of the converter leg or the positive output node at a second end.

2. The power converter of claim 1, wherein the upper portion of the converter leg comprises at least two diodes and the flying capacitor is connected between the at least two diodes.

3. The power converter of claim 2, wherein the power converter comprises an interleaved power converter comprising an additional converter leg connected to the positive output node and the negative output node and an additional inductor connected to the additional converter leg.

4. The power converter of claim 1, further comprising a controller programmed to execute the steps of
sequentially switching the at least two switches to a non-conduction mode wherein the switch connected farthest from the intermediate node is switched first; and then
sequentially switching the at least two switches to a conduction mode wherein the switch connected nearest to the intermediate node is switched first.

5. The power converter of claim 1, wherein the lower portion of the converter leg comprises more than two switches, the upper portion of the converter leg comprises more than two diodes, and a plurality of flying capacitors are connected to the converter leg, wherein each of the flying capacitors is connected between a distinct pair of switches at the first end and a distinct pair of diodes at the second end.

6. The power converter of claim 1, wherein the at least one flying capacitor is connected to the positive output node at the second end.

7. The power converter of claim 6, wherein exactly one diode is connected to the upper portion of the converter leg.

8. The power converter of claim 6, wherein the lower portion of the converter leg comprises more than two switches and the flying capacitor comprises a plurality of flying capacitors connected to the converter leg, wherein each of the flying capacitors is connected between a distinct pair of switches at the first end and to the positive output node at the second end.

9. The power converter of claim 6, wherein the power converter comprises an interleaved power converter comprising an additional converter leg connected to the positive output node and the negative output node and an additional inductor connected to the additional converter leg.

10. The power converter of claim 1, wherein the switches comprise wide bandgap materials.

11. A solar power generation system comprising:
photovoltaic modules for generating DC power; and
a partial power converter comprising:
an input terminal connected to the photovoltaic modules;
a converter leg comprising an upper portion comprising at least one diode connected to a positive output node of an output terminal of the partial power converter and a lower portion comprising at least two switches connected in series with each other and with the at least one diode and to a negative output node of the output terminal of the partial power converter;
an inductor connected between the input terminal and an intermediate node between the upper portion and the lower portion of the converter leg;
an output capacitor connected between the input terminal of the partial power converter and the positive output node; and
at least one flying capacitor connected between the at least two switches at a first end and to either of the upper portion of the converter leg or the positive output node at a second end.

12. The solar power generation system of claim 11, wherein the upper portion of the converter leg comprises at least two diodes and the flying capacitor is connected between the at least two diodes at the second end.

13. The solar power generation system of claim 11, wherein the at least one flying capacitor is connected to the positive output node at the second end.

14. The solar power generation system of claim 13 wherein exactly one diode is connected to the upper portion of the converter leg.

15. The solar power generation system of claim 11, further comprising a controller programmed to execute the steps of
sequentially switching the at least two switches to a non-conduction mode wherein the switch connected farthest from the intermediate node is switched first; and then
sequentially switching the at least two switches to a conduction mode wherein the switch connected nearest to the intermediate node is switched first.

16. The solar power generation system of claim 11, wherein the partial power converter comprises an interleaved power converter comprising an additional converter leg connected to the positive output node and the negative output node and an additional inductor connected to the additional converter leg.
